(19) United States
(12) Patent Application Publication
(10) Pub. No.: US 2006/0286413 A1
(43) Pub. Date: Dec. 21, 2006

(54) Magnetic caplayers for corrosion improvement of granular perpendicular recording media

(75) Inventors: Connie Chunling Liu, San Jose, CA (US); Xiaoding Ma, Fremont, CA (US); Qixu Chen, Milpitas, CA (US); Shanghsien Rou, Fremont, CA (US); Mariana Rodica Munteanu, Santa Clara, CA (US); Miaogen Lu, Fremont, CA (US); Michael Zyee-Shan Wu, San Jose, CA (US); Kueir-Weei Chour, San Jose, CA (US); Kuo Hsing Hwang, San Jose, CA (US)

Correspondence Address: MORRISON & FOERSTER LLP, 1650 TYSONS BOULEVARD, SUITE 300, MCLEAN, VA, 22102, US

(73) Assignee: SEAGATE TECHNOLOGY LLC, Scotts Valley, CA (US)

(21) Appl. No.: 11/154,637

(22) Filed: Jun. 17, 2005

(51) Int. Cl. G11B 5/66

(52) U.S. Cl. 428/829; 428/830; 428/836.2

(57) ABSTRACT

A magnetic recording medium having a substrate, a granular magnetic layer and a magnetic cap layer covered with carbon overcoat, in this order, wherein both the granular magnetic and magnetic cap layers contain magnetic grains and non-magnetic grain boundaries, and further wherein the magnetic cap layer has denser grain boundaries and the magnetic cap layer contains substantially no oxide is disclosed. The magnetic cap layer serves as both magnetic layer and corrosion barrier for lower HMS.

### RELATED APPLICATIONS

This application is related to U.S. Ser. No. 10/776,223, filed Feb. 12, 2004, entitled “Pre-carbon Ar etching for granular media,” and Attorney Docket No. 146712001800, filed Apr. 27, 2005, entitled “Epitaxially Grown Non-oxide Magnetic Layers for Granular Perpendicular Recording Media Applications,” which are incorporated herein by reference.

### FIELD OF INVENTION

The present invention relates to improved, high recording performance magnetic recording media comprising at least two magnetic layers, preferably in contact with each other, for corrosion improvement of granular perpendicular recording media.

### BACKGROUND

Thin film magnetic recording media, wherein a fine-grained polycrystalline magnetic alloy layer serves as the magnetic recording layer, are generally classified as “longitudinal” or “perpendicular,” depending on the orientation of the magnetic domains (bits) of the magnetic grains in the magnetic recording layer. FIG. 1, obtained from Magnetic Disk Drive Technology by Kanu G. Ashar, 322 (1997), shows magnetic bits and transitions in longitudinal and perpendicular recording.

The increasing demands for higher areal recording density impose increasingly greater demands on thin film magnetic recording media in terms of coercivity (Hc), remanent coercivity (Hcr), magnetic remanance (Mr), which is the magnetic moment per unit volume of ferromagnetic material, coercivity squareness (S*), signal-to-medium noise ratio (SMNR), and thermal stability of the media. Thermal stability of a magnetic grain is to a large extent determined by KᵤV, where Kᵤ is the magnetic anisotropy constant of the magnetic layer and V is the volume of the magnetic grain. V depends on the magnetic layer thickness (t); as t is decreased, V decreases. Furthermore, the increasing demands for higher areal recording density impose increasingly greater demands on flying the head lower because the output voltage of a disk drive (or the readback signal of a reader head in disk drive) is proportional to 1/exp(HMS), where HMS is the space between the head and the media. These parameters are important to the recording performance and depend primarily on the microstructure of the materials of the media.

Granular perpendicular recording media is being developed for its capability of further extending the areal recording density as compared to conventional perpendicular recording media which is limited by the existence of strong exchange coupling between magnetic grains. In contrast to conventional perpendicular media wherein the magnetic layer is typically sputtered in the presence of inert gas, most commonly argon (Ar), deposition of a granular perpendicular magnetic layer utilizes a reactive sputtering technique wherein oxygen (O₂) is introduced, for example, in a gas mixture of Ar and O₂, resulting in the incorporation of oxides to achieve smaller and isolated grains. Not wishing to be bound by theory, it is believed that the introduction of O₂ provides a source of oxygen that migrates into the grain boundaries forming oxides within the grain boundaries, and thereby providing a granular perpendicular structure having a reduced exchange coupling between grains.

However, the migration of oxygen and the oxidation process produces a granular perpendicular magnetic layer having a porous structure. As a result, the film has a higher surface roughness and lower corrosion resistance compared to longitudinal alloy media. The corrosion tests show that the corrosion performance of granular media is poor and even 40 Å carbon overcoat cannot protect it from environmental attacks. The recent work indicates that the root cause of the poor corrosion performance of granular media is the incomplete coverage of carbon overcoat on the media surface due to high nano-scale surface roughness, porous oxide grain boundary, and/or poor carbon adhesion to oxides. To improve the corrosion performance, there is a need to improve the surface coverage of the carbon overcoat. There are several methods proposed to improve the corrosion protection. One is to use ion etch before carbon deposition to treat the surface of magnetic layers. The results showed that the corrosion performance was improved by the pre-carbon etching. However, one disadvantage of this method is that, since etch is done directly on the magnetic layer, the etch process will remove the magnetic materials and as a result, will alter the magnetic properties. Etch process also has inconsistency issue, which will cause extra difficulty for media manufacturing.

Then another method was proposed to deposit a thin non-magnetic caplayer on top of magnetic layer and follow by ion etching prior to carbon coating to improve the carbon surface coverage. As one would recognize, the continuing drive for increased areal recording density in the magnetic recording media industry mandates reduction of the head-to-medium separation, or more particularly the head to magnetic layer separation. As such, an increase in areal density usually requires a reduction in the thicknesses of the layers between the magnetic layer and the head, namely the protective overcoat and the lubricant layer, that constitute part of the head to magnetic layer separation. However the method of adding a non-magnetic caplayer to improve has the disadvantages of creating the HMS penalty from the caplayer and creates an additional process step of ion etching. The applicants recognized that the better solution would be one with no HMS penalty and no ion etching.

One role of the protective overcoat is to prevent corrosion of the underlying magnetic layer, which is an electrochemical phenomenon dependent upon factors such as environmental conditions, e.g., humidity and temperature. However, as the protective overcoat thickness is reduced to below 40 Å, the magnetic layer becomes more vulnerable to corrosion. Such low thicknesses reduce the ability of the protective overcoat to maintain adequate corrosion protection.

Accordingly, there exists a need for perpendicular magnetic recording media having a high recording areal density, and a significantly reduced head-to-medium separation while simultaneously providing adequate resistance to environmental attacks, such as corrosion. There exists a particular need for high recording areal density magnetic recording media having a combined protective overcoat and lubricant film thickness less than about 60 Å and exhibiting substantially no corrosion. There is a need for granular perpendicular recording media having a magnetic layer exhibiting improved corrosion resistance while maintaining the magnetic properties suitable for high density perpendicular recording.

### SUMMARY OF THE INVENTION

The embodiments of the invention are directed to a longitudinal or perpendicular recording medium having an improved segregation within the magnetic layers

As will be realized, this invention is capable of other and different embodiments, and its details are capable of modifications in various obvious respects, all without departing from this invention. Accordingly, the drawings and description are to be regarded as illustrative in nature and not as restrictive.

### BRIEF DESCRIPTION OF THE DRAWINGS

FIG. 1 shows (a) longitudinal and (b) perpendicular recording bits.

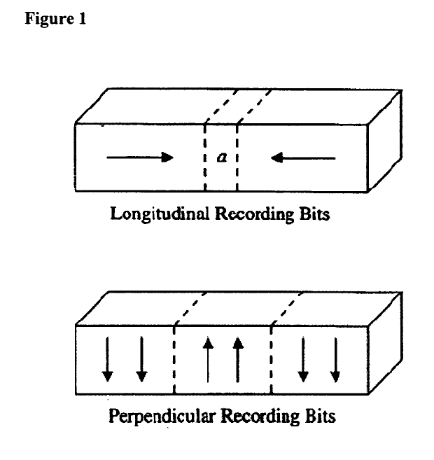

FIG. 2 shows an embodiment of a structure of media of this invention.

FIG. 3 shows corrosion performance of the media in terms of CoOx measured by ESCA as a function of the thickness of the magnetic cap layer. The media has a 35 Å carbon overcoat.

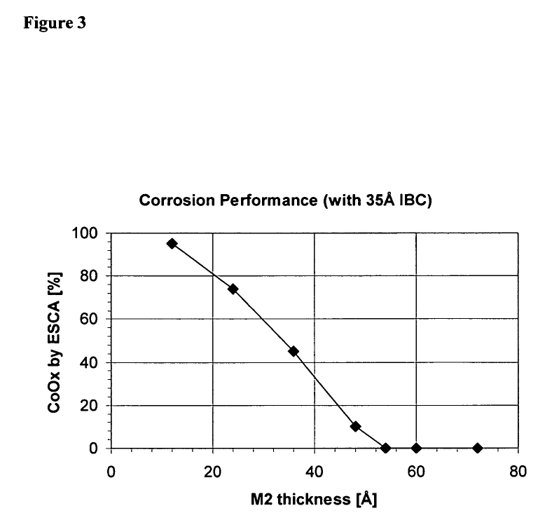

### DETAILED DESCRIPTION

Magnetic recording media having Co—Cr—Pt—B and Co—Cr—Ta alloys contain B and Ta to improve the segregation of Cr in the magnetic layer. A better segregation profile of Cr leads to a sharper transition between the magnetic grains and the non-magnetic Cr-rich grain boundaries, and thus, the recording media is expected to have higher saturation magnetization (Ms) and magnetocrystalline anisotropy (Kᵤ) and narrower intrinsic switching field distribution.

The embodiments of the invention comprise a method and apparatus for a magnetic recording media having improved bit-error rate (BER) performance with no HMS penalty and improved manufacturability. The embodiments relates to a new method to deposit a layer or multi-layers of non-oxide magnetic alloys (which could be called magnetic caplayer) on top of the granular magnetic layer to protect granular media from corrosion. The process of such manufacturing the magnetic caplayers could be similar to the conventional longitudinal media sputter process with neither reactive sputtering nor oxide additives in the target. The composition of the magnetic caplayer could be a CoCr-containing alloy. The microstructure of the caplayer could be crystalline and/or amorphous. The thickness of caplayer can be between 5 to 500 Å.

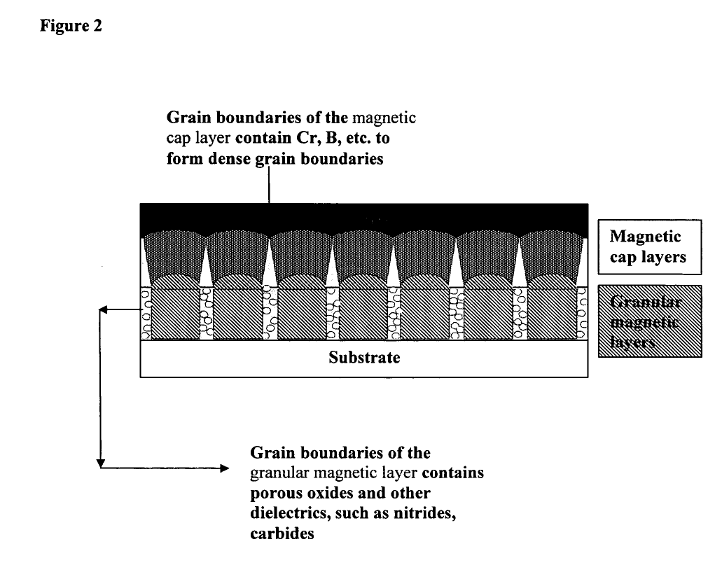

FIG. 2 shows an embodiment of this invention in which the granular magnetic layer could have a granular structure and the magnetic cap layer could have a composition such as Co_{100-x-y-z-α}CrₓPt_{y}B_{z} X_{α} Y_{β}. In the magnetic cap layer, elements like B and Cr would be segregated into grain boundaries and form dense grain boundaries. During the deposition of the magnetic cap layer, bias and heat can be applied to promote the B, Cr-like elements to segregate to the grain boundaries. The magnetic cap layer with dense grain boundaries would block the corrosion path for transmission of oxygen and materials from the environment to the porous oxide grain boundaries in the granular magnetic layer. Since the magnetic cap layer contributes to the magnetic performance of the media, there is no HMS penalty. Also, the media according to the embodiments of this invention would not require undergoing an etching process, though it is still an option.

The embodiments of the invention provide magnetic recording media suitable for high areal recording density exhibiting high SMNR. An embodiment of the invention achieve such technological advantages by forming a soft underlayer. A “soft magnetic material” is a material that is easily magnetized and demagnetized. As compared to a soft magnetic material, a “hard magnetic” material is one that neither magnetizes nor demagnetizes easily.

The underlayer is “soft” because it is made up of a soft magnetic material, which is defined above, and it is called an “underlayer” because it resides under a recording layer. In a preferred embodiment, the soft layer is amorphous. The term “amorphous” means that the material of the underlayer exhibits no predominant sharp peak in an X-ray diffraction pattern as compared to background noise. The term “amorphous” encompasses nanocrystallites in amorphous phase or any other form of a material so long the material exhibits no predominant sharp peak in an X-ray diffraction pattern as compared to background noise. The soft magnetic underlayer can be fabricated as single layers or a multilayer. The amorphous soft underlayer is relatively thick compared to other layers. The amorphous soft underlayer materials include a Cr-doped Fe-alloy-containing underlayer, wherein the Fe-alloy could be CoFeZr, CoFeTa, FeCoZrB and FeCoB.

A seedlayer could be optionally included in the embodiments of this invention. A seedlayer is a layer lying in between the substrate and the underlayer. Proper seedlayer can also control anisotropy of the soft underlayer by promoting microstructure that exhibit either short-range ordering under the influence of magnetron field or different magnetostriction. A seedlayer could also alter local stresses in the soft underlayer.

Preferably, in the underlayer of the perpendicular recording medium of the embodiments of the invention, an easy axis of magnetization is directed in a direction substantially transverse to a traveling direction of the magnetic head. This means that the easy axis of magnetization is directed more toward a direction transverse to the traveling direction of the read-write head than toward the traveling direction. Also, preferably, the underlayer of the perpendicular recording medium has a substantially radial or transverse anisotropy, which means that the domains of the soft magnetic material of the underlayer are directed more toward a direction transverse to the traveling direction of the read-write head than toward the traveling direction. In one embodiment, the direction transverse to the traveling direction of the read-write head is the direction perpendicular to the plane of the substrate of the recording medium.

In accordance with embodiments of this invention, the substrates that may be used in the embodiments of the invention include glass, glass-ceramic, NiP/aluminum, metal alloys, plastic/polymer material, ceramic, glass-polymer, composite materials or other non-magnetic materials. Glass-ceramic materials do not normally exhibit a crystalline surface. Glasses and glass-ceramics generally exhibit high resistance to shocks.

The media could further include an interlayer. The interlayer can be made of more than one layer of non-magnetic materials. The purpose of the interlayer is to prevent an interaction between the amorphous soft magnetic underlayer and recording layer. The interlayer could also promote the desired properties of the recording layer.

The underlayer and magnetic recording layer could be sequentially sputter deposited on the substrate, typically by magnetron sputtering, in an inert gas atmosphere. A carbon overcoat could be typically deposited in argon with nitrogen, hydrogen or ethylene. Conventional lubricant topcoats are typically less than about 20 Å thick.

Amorphous materials as soft underlayer materials lack of long-range order in the amorphous material. Without a long-range order, amorphous alloys have substantially no magnetocrystalline anisotropy. The use of amorphous soft underlayer could be one way of reducing noise caused by ripple domains and surface roughness. An amorphous soft underlayer could produce smoother surfaces as compared to a polycrystalline underlayer. Therefore, amorphous soft underlayer could be one way of reducing the roughness of the magnetic recording media for high-density perpendicular magnetic recording. The surface roughness of the amorphous soft underlayer is preferably below 1 nm, more preferably below 0.5 nm, and most preferably below 0.2 nm.

In accordance with this invention, the average surface roughness (Rₐ) refers to the arithmetic average of the absolute values of the surface height deviations measured from a mean plane. The value of the mean plane is measured as the average of all the Z values within an enclosed area. The mean can have a negative value because the Z values are measured relative to the Z value when the microscope is engaged. This value is not corrected for tilt in the plane of the data; therefore, plane fitting or flattening the data will change this value.
Rₐ=[|Z₁|+|Z_{2|+ . . . +|Z}ₙ|]/N

The surface parameters of a layer such as that of the soft underlayer could be measured by atomic force microscope (AFM). The AFM used to characterize this invention has the trade name NanoScope.® The statistics used by the AFM are mostly derived from ASME B46.1 (“Surface Texture: Surface Roughness, Waviness and Law”) available from the American Society of Mechanical Engineers, which is incorporated herein by reference.

In the preferred embodiment of the perpendicular media, it could be easier to saturate the sample in radial direction than in circumferential direction. In this situation, the radial and circumferential directions are called the easy and hard axis, respectively. The underlayer of the disk could also have radial anisotropy. “Anisotropy” could be determined as described in U.S. Pat. No. 6,703,773, which is incorporated herein in entirety by reference.

The advantageous characteristics attainable by the present invention, particularly, as related to reduction or elimination of DC noise and improved corrosion resistance, are illustrated in the following examples.

### EXAMPLES

All samples described in this disclosure were fabricated with DC magnetron sputtering except carbon films were made with AC magnetron sputtering.

In one embodiment of the invention, the media structure comprises, but not limit to following layers:

1. Substrate: polished glass, glass ceramics, or Al/NiP.

2. The granular medium layers including: adhesion layer (AL), one ore more soft underlayers (SUL), seed layer (SL), one or more interlayers (IL) and the oxide containing magnetic layers (M1). Examples of layer composition and thickness are as following:

AL: Ti, 0-100 Å.

SUL: Co_{100-x-y-z}—Feₓ—B_{y}—Cr_{z}(10≦x≦70, 0≦y≦30, 0≦z≦30), or Co_{100-x-y-z}—Zrₓ—Ta_{y}—Cr_{z} (x<30, y<30, z<30) or Co_{100-x-y-z}—Zrₓ—Nb_{y}—Cr_{z} (x<30, y<30, z<30); SUL thickness: single SUL: 100-5000 Å, anti-ferromagnetic coupled (AFC) SUL: bottom SUL 50-2500 Å/spacer/top

SUL: 50-2500 Å.

SL: Cu, Ag, Au, Ta; SL thickness: 1-50 Å

IL: Ru, RuX, and/or RuXO (X=Cr, Ta, W); Interlayer thickness: 10-500 Å.

Granular magnetic layers: Co_{100-x-y-z}Ptₓ(A)_{y}(MB)_{z} (A is the optional 3^{rd} additives, such as Cr. MB is dielectric components, such as SiO₂, TiO₂, Nb₂O₅, WO₃, Al₂O₃, Si₃N₄, C SiC and so on). 1≦x≦30, 0≦y≦30, 1≦z≦30; M1 thickness 0-500 Å.

3. Non-oxide containing magnetic cap layers of composition Co_{100-x-y-z-α}—CrₓPt_{y}B_{z} X_{α} (X is the optional 5^{th} additives, such as Cu, Au, Ta, V). 0≦x≦30, 0≦y≦30, 0≦z≦30, 0≦α≦10 was sputtered with a layer thickness of 5-500 Å.

4. Carbon thickness varies from 5-100 Å.

Some embodiments of the perpendicular recording media of the invention include the following manufacturing steps:

Step 1: A soft magnetic structure including adhesion layer, soft magnetic layers, and any desired nonmagnetic lamination layers are deposited onto a substrate. In a preferred embodiment, the soft magnetic structure is 10-500 nm thick. Orienting seed layer and underlayer structures are deposited on top of the soft magnetic structure. In a preferred embodiment, the underlayer is an hcp ruthenium (Ru) containing alloy with a <0001> preferred growth orientation.

Step 2: The granular magnetic layer is deposited on top of the underlayer so as to grow with an hcp <0001> preferred growth orientation. It comprises a Co—Pt containing alloy that also includes other nonmagnetic (non-ferromagnetic) elements. In a preferred embodiment, the Pt concentration is greater than about 10 atomic percent (at %). The granular magnetic layer is deposited so as to form a compositionally segregated microstructure wherein the magnetic particles comprise higher concentrations of Co and Pt, while the boundaries between magnetic particles comprise higher concentrations of other non-magnetic elements and lower cobalt concentration, such that the boundary material is substantially non-magnetic. In one preferred embodiment, the nonmagnetic material comprises reactive sputtering induced CoO. In another preferred embodiment, the nonmagnetic material comprises an oxide, carbide and/or nitride formed from an element or oxide, carbide and/or nitride material included in a sputter target. In a more preferred embodiment, the granular magnetic layer deposition is performed at a sputter gas pressure of about >20 mTorr and 5 to 50 volume percent of the layer is nonmagnetic material grain boundary by TEM.

Step 3: In a preferred embodiment, the magnetic cap layer also comprises a Co-containing magnetic layer. In another preferred embodiment, the magnetic cap layer further comprises a <0001> growth oriented film. The magnetic cap layer deposition is performed at a sputter gas pressure of <20 mTorr. In a preferred embodiment the magnetic cap layer could be deposited without reactive oxidation so as to form a denser microstructure than the granular magnetic layer. In another embodiment, the oxide material in the sputter target is removed, or reduced as compared to the granular magnetic layer. In the various embodiments, the overall concentration of non-magnetic elements and specifically the concentration of nonmagnetic materials at magnetic particle boundaries is lower than in the granular magnetic layer case.

Step 4: A protective overcoat, typically comprising an amorphous C-alloy structure and a polymer lubricant could be deposited directly on the top of granular magnetic layer.

In the claims of the terms “a” and “an” mean one or more. This application discloses several numerical range limitations that support any range within the disclosed numerical ranges even though a precise range limitation is not stated verbatim in the specification because this invention can be practiced throughout the disclosed numerical ranges. Finally, the entire disclosure of the patents and publications referred in this application are hereby incorporated herein in entirety by reference.

1. A magnetic recording medium comprising a substrate, a granular magnetic layer, a magnetic cap layer, and a carbon-containing or a silicon-containing overcoat directly on the magnetic cap layer, in this order, wherein the magnetic cap layer protects the magnetic recording medium from corrosion.

2. A magnetic recording medium comprising a substrate, a granular magnetic layer, and a magnetic cap layer, in this order, wherein the magnetic cap layer protects the granular media from corrosion, and further wherein the magnetic cap layer has denser grain boundaries than that of the granular magnetic layer.

3. The magnetic recording medium of claim 1, wherein grain boundaries of the magnetic cap layer are substantially oxide-free.

4. The magnetic recording medium of claim 1, wherein the magnetic cap layer has a higher density and a lower average porosity at grain boundaries than that of the granular magnetic layer.

5. The magnetic recording medium of claim 1, wherein the magnetic cap layer has a lower average roughness than that of the granular magnetic layer.

6. The magnetic recording medium of claim 1, wherein the magnetic cap layer serves as both a magnetically functional layer and a corrosion protection layer.

7. The magnetic recording medium of claim 1, wherein a thickness of the magnetic cap layer is such that a CoOx percentage measured by ESCA after 4-day 80° C./80% relative humidity test is substantially negligible.

8. The magnetic recording medium of claim 1, wherein a thickness of the magnetic cap layer is greater than about 10 Å.

9. The magnetic recording medium of claim 1, wherein the magnetic cap layer comprises Co, Cr, Pt, B and optionally X, wherein X is selected from the group consisting of Cu, Au, Ta and V.

10. The magnetic recording medium of claim 1, wherein the magnetic recording medium is a perpendicular medium further comprising a soft underlayer.

11. A method of manufacturing a magnetic recording medium comprising a obtaining a substrate, depositing a granular magnetic layer, depositing a magnetic cap layer, and depositing a carbon-containing or a silicon-containing overcoat directly on the magnetic cap layer, in this order, wherein the magnetic cap layer protects the magnetic recording medium from corrosion.

12. The method of claim 11, wherein the grain boundaries of the magnetic cap layer are substantially oxide-free.

13. The method of claim 11, wherein the magnetic cap layer has a higher density and a lower average porosity at grain boundaries than that of the granular magnetic layer.

14. The method of claim 11, wherein the magnetic cap layer has a lower average roughness than that of the granular magnetic layer.

15. The method of claim 11, wherein the magnetic cap layer serves as both a magnetically functional layer and a corrosion protection layer.

16. The method of claim 11, wherein a thickness of the magnetic cap layer is such that a CoOx percentage measured by ESCA after 4-day 80° C./80% relative humidity test is substantially negligible.

17. The method of claim 11, wherein a thickness of the magnetic cup layer is greater than about 10 Å.

18. The method of claim 11, wherein the magnetic cap layer comprises Co, Cr, Pt, B and optionally X, wherein X is selected from the group consisting of Cu, Au, Ta and V.

19. The method of claim 11, wherein the magnetic recording medium is a perpendicular medium further comprising a soft underlayer.

20. The magnetic recording medium of claim 2, wherein grain boundaries of the granular magnetic layer comprise an oxide-containing material.
